(19) United States
(12) Patent Application Publication
(10) Pub. No.: US 2024/0304220 A1
(43) Pub. Date: Sep. 12, 2024

(54) DISK DRIVE ASSEMBLY, MOUNTING CAGE ASSEMBLY AND SERVER

(71) Applicants: INVENTEC (PUDONG) TECHNOLOGY CORPORATION, Shanghai (CN); INVENTEC CORPORATION, Taipei City (TW)

(72) Inventors: Wen-Long HUANG, Shanghai City (CN); Xishan SHEN, Shanghai City (CN)

(73) Assignees: INVENTEC (PUDONG) TECHNOLOGY CORPORATION, Shanghai (CN); INVENTEC CORPORATION, Taipei City (TW)

(21) Appl. No.: 18/125,082

(22) Filed: Mar. 22, 2023

(30) Foreign Application Priority Data
Mar. 6, 2023 (CN) 202310207429.7

(51) Int. Cl. G11B 33/12

(52) U.S. Cl. CPC G11B 33/123

(57) ABSTRACT

A disk drive assembly includes a mounting cage, at least one disk drive, a first assembly structure and a second assembly structure. The mounting cage has a front side, a back side and at least one installation space. The back side is opposite to the front side, and the at least one installation space extends from the front side to the back side. The at least one disk drive is mounted in the at least one installation space. The first assembly structure and the second assembly structure are located adjacent to the front side and the back side of the mounting cage, respectively.

### CROSS-REFERENCE TO RELATED APPLICATIONS

This non-provisional application claims priority under 35 U.S.C. § 119(a) on Patent Application No(s). 202310207429.7 filed in CHINA, on Mar. 6, 2023, the entire contents of which are hereby incorporated by reference.

### BACKGROUND OF THE INVENTION

### Technical Field of the Invention

The invention relates to an electronic assembly, more particularly to a disk drive assembly.

### Description of the Related Art

Nowadays, the information technology develops rapidly. Most of enterprises may do various tasks on the business via servers, such as storing data. In order to further improve the efficiency of doing tasks on the business, a plurality of disk drives may be installed in the server to speed up the analysis and processing of data.

Generally, a mounting cage may be fixed to a casing via a plurality of screws at a front side of the server. However, the installation space on the front side of the server may be occupied by the disk drive. Thus, the difficulty of fastening screws is increased. Additionally, repeatedly fastening a plurality of screws may also takes a lot of time. Therefore, how to reduce the time for installing the mounting cage of the server and allow the installation to be more convenient is an important issue to be solved.

### SUMMARY OF THE INVENTION

The invention provides a disk drive assembly, a mounting cage assembly and a server so as to reduce the time for installing the mounting cage of the server and allow the installation to be more convenient.

One embodiment of the invention provides a disk drive assembly including a mounting cage, at least one disk drive, a first assembly structure and a second assembly structure. The mounting cage has a front side, a back side and at least one installation space. The back side is opposite to the front side, and the at least one installation space extends from the front side to the back side. The at least one disk drive is mounted in the at least one installation space. The first assembly structure and the second assembly structure are located adjacent to the front side and the back side of the mounting cage, respectively.

Another embodiment of the invention provides a mounting cage assembly including a mounting cage, a first assembly structure and a second assembly structure. The mounting cage has a front side, a back side and at least one installation space. The back side is opposite to the front side, and the at least one installation space extends from the front side to the back side. The first assembly structure and the second assembly structure are close to the front side and the back side of the mounting cage, respectively.

Another embodiment of the invention provides a server including a casing and a disk drive assembly. The disk drive assembly includes a mounting cage, at least one disk drive, a first assembly structure and a second assembly structure. The mounting cage has a front side, a back side and at least one installation space. The back side is opposite to the front side, and the at least one installation space extends from the front side to the back side. The at least one disk drive is mounted in the at least one installation space. The first assembly structure and the second assembly structure are located adjacent to the front side and the back side of the mounting cage, respectively.

According to the disk drive assembly, the mounting cage assembly and the server disclosed by above embodiments, due to the addition of the second assembly structure at the back side with larger space of the disk drive assembly, the front side with small space of the disk drive assembly needs to lock a single screw to fix the disk drive assembly to the casing merely without locking a plurality of screws. Therefore, the time for installing the mounting cage of the server may be reduced and the convenience of installation may be increased.

In addition, since the second assembly structure is located at the back side of the disk drive assembly, when removing the disk drive assembly, the operator may check whether the external cables are completely removed from the disk drive assembly so as to avoid tearing the external cables when removing the disk drive assembly.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1 is a perspective view of a server in accordance with an embodiment of the invention;

FIG. 2 is an exploded view of the server in FIG. 1;

FIG. 3 is a perspective view of a disk drive assembly in FIG. 1;

FIG. 4 is an exploded view of the disk drive assembly in FIG. 1;

FIG. 5 is a partial enlarged exploded view of the server in FIG. 1;

FIG. 6 is a cross-sectional view showing that a second assembly structure in FIG. 1 is in an assembled state; and

FIG. 7 is a cross-sectional view showing that the second assembly structure in FIG. 1 is in a released state.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present invention, such as technical and scientific terms, have its own meanings and can be comprehended by those skilled in the art, unless the terms are additionally defined in the present invention. That is, the terms used in the following paragraphs should be read on the meaning commonly used in the related fields and will not be overly explained, unless the terms have a specific meaning in the present invention.

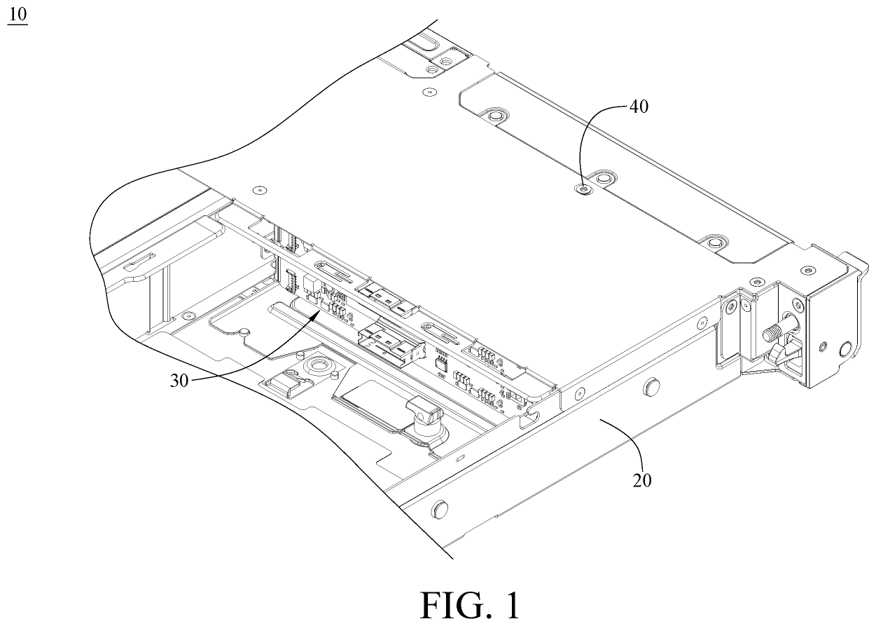

Please refer to FIG. 1, which is a perspective view of a server 10 in accordance with an embodiment of the invention. In this embodiment, the server 10 includes a casing 20, a disk drive assembly 30 and a fastener 40.

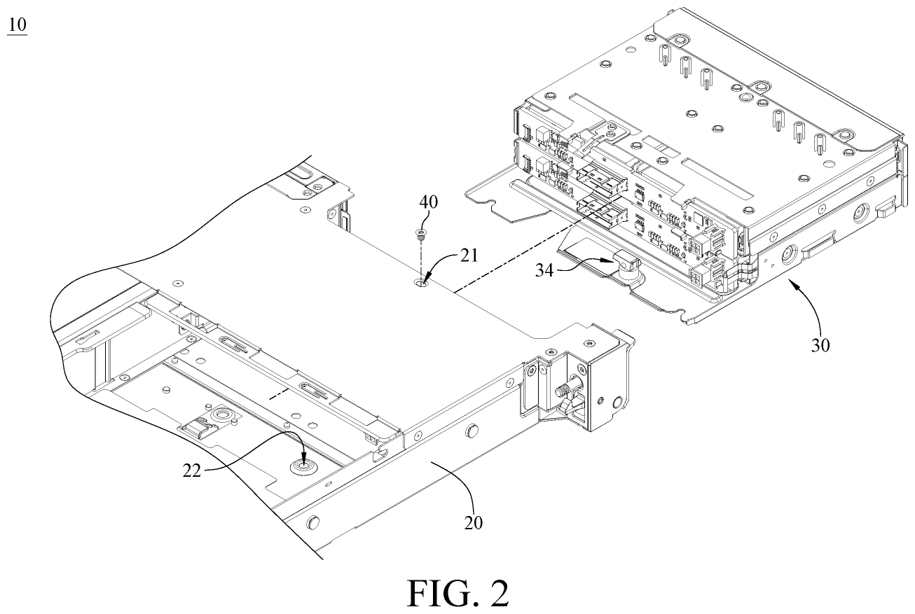

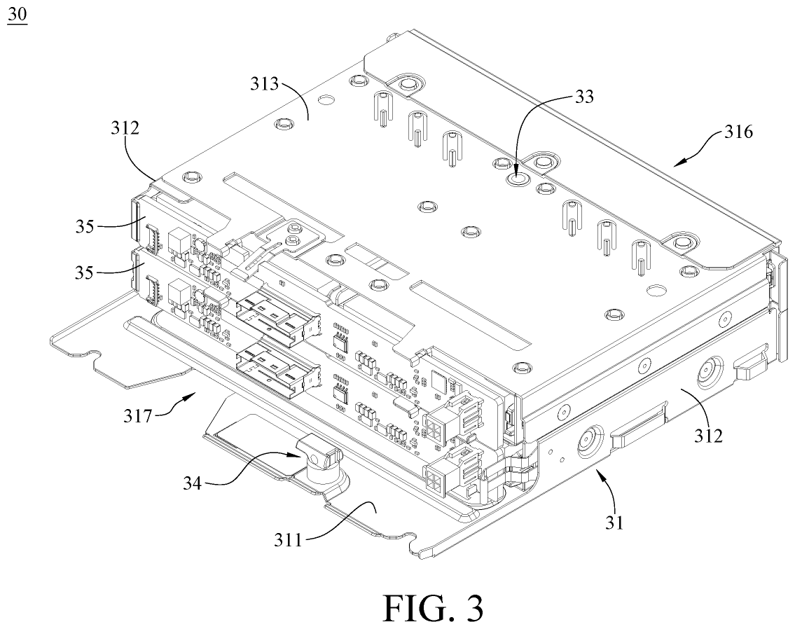

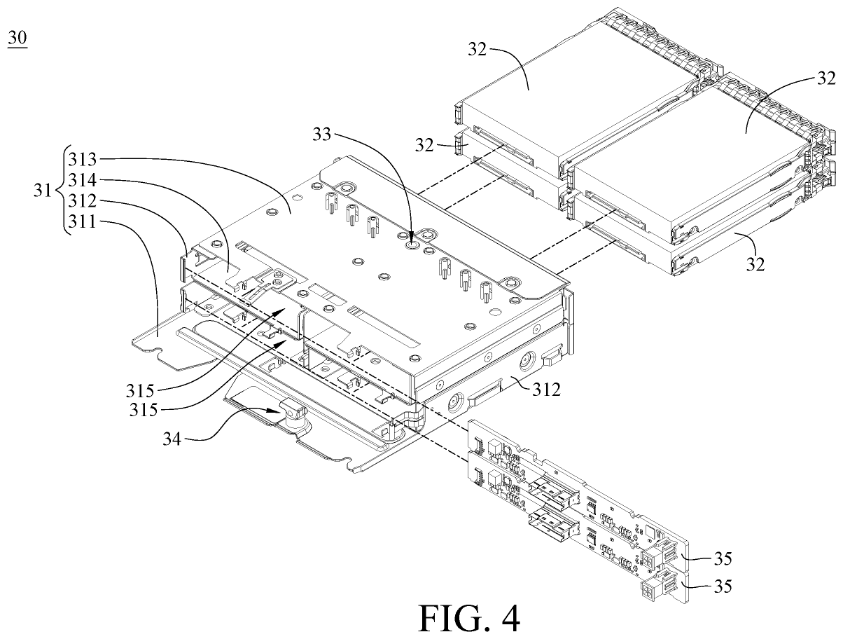

Please refer to FIG. 2 to FIG. 4, where FIG. 2 is an exploded view of the server 10 in FIG. 1, FIG. 3 is a perspective view of a disk drive assembly 30 in FIG. 1, and FIG. 4 is an exploded view of the disk drive assembly 30 in FIG. 1.

The disk drive assembly 30 includes a mounting cage 31, four disk drives 32, a first assembly structure 33, a second assembly structure 34 and two backplanes 35. The mounting cage 31 includes a bottom plate 311, two side plates 312, a top plate 313 and a partition 314. The two side plates 312 are connected to two opposite sides of the bottom plate 311, respectively. Two opposite sides of the top plate 313 are connected to the two side plates 312, respectively. The partition 314 is located between the bottom plate 311 and the top plate 313 and connected to the two side plates 312. Accordingly, the bottom plate 311, the two side plates 312, the top plate 313 and the partition 314 together form two installation spaces 315. The mounting cage 31 has a front side 316 and a back side 317. The back side 317 is opposite to the front side 316, and the two installation spaces 315 extend from the front side 316 to the back side 317. The four disk drives 32 are mounted in the two installation spaces 315, respectively.

The disk drive assembly 30 is fixed to the casing 20 via the fastener 40. The casing 20 has a through hole 21 and an engagement hole 22. The first assembly structure 33 is, for example, a screw hole, and the fastener 40 is, for example, a screw. The fastener 40 passes through the through hole 21, and is screwed into the first assembly structure 33. The first assembly structure 33 and the second assembly structure 34 are located adjacent to the front side 316 and the back side 317 of the mounting cage 31, respectively. The first assembly structure 33 is located on the top plate 313, and the second assembly structure 34 is located on the bottom plate 311.

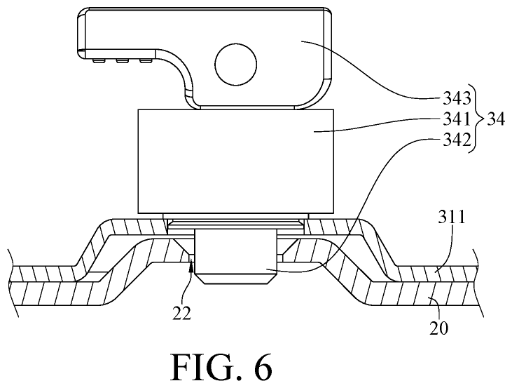

Please refer to FIG. 6 temporarily, which is a cross-sectional view showing that a second assembly structure in FIG. 1 is in an assembled state. The second assembly structure 34 includes a fixed member 341, an engagement member 342 and a handheld member 343. The fixed member 341 is fixed on the bottom plate 311. The engagement member 342 is movably disposed at the fixed member 341. The handheld member 343 is, for example, pivotally connected to the engagement member 342, and is configured to force the engagement member 342 to move relative to the fixed member 341, so that the engagement member 342 is engaged with the engagement hole 22 of the casing 20. Please refer to FIG. 2 to FIG. 4 again. The two backplanes 35 are, for example, circuit boards, and are located at the back side 317 of the mounting cage 31. The four disk drives 32 are plugged into the two backplanes 35, respectively, and the two backplanes 35 are configured for external cables (not shown) to be plugged therein.

In this embodiment, the engagement member 342 of the second assembly structure 34 is engaged with the engagement hole 22 of the casing 20. Thus, the disk drive assembly 30 is allowed to be fixed to the casing 20 merely by one fastener 40. Therefore, the mounting cage 31 can be stably fixed to the casing 20 with most of the space on the front side 316 occupied by the four disk drives 32. Accordingly, the time for installing the mounting cage of the server can be reduced and the installation is allowed to be more convenient.

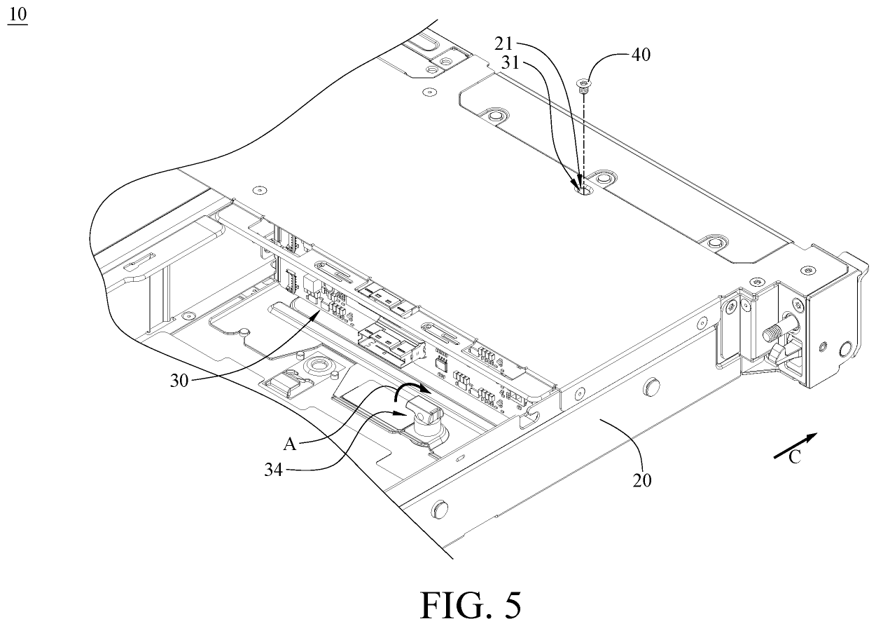

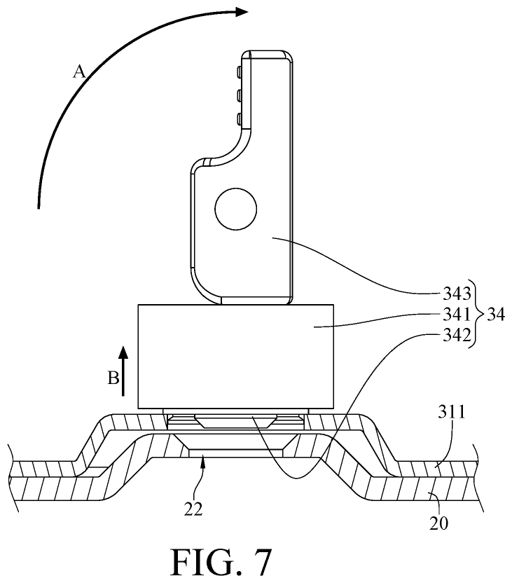

Please refer to FIG. 5 to FIG. 7, where FIG. 5 is a partial enlarged exploded view of the server in FIG. 1, and FIG. 7 is a cross-sectional view showing that the second assembly structure in FIG. 1 is in a released state.

In this embodiment, the fastener 40 is screwed into the first assembly structure 33, and the engagement member 342 of the second assembly structure 34 is engaged with the engagement hole 22 of the casing 20, so that the second assembly structure 34 is in an assembled state, where the disk drive assembly 30 is fixed to the casing 20. When the disk drive assembly 30 is required to be removed from the casing 20, the fastener 40 is firstly removed from the first assembly structure 33. Then, the handheld member 343 of the second assembly structure 34 is pulled along a direction A, and the handheld member 343 forces the engagement member 342 to move relative to the fixed member 341 along a direction B, so that the engagement member 342 is disengaged from the engagement hole 22 of the casing 20. At this time, the second assembly structure 34 is changed from the assembled state to the released state, and the bottom plate 311 of the disk drive assembly 30 is separated from the casing 20. Finally, the disk drive assembly 30 is removed from the casing 20 along a direction C.

On the contrary, when the disk drive assembly 30 is required to be installed at the casing 20, the disk drive assembly 30 is firstly put into the casing 20 along a direction opposite to the direction C. Then, the handheld member 343 of the second assembly structure 34 is pulled along a direction opposite to the direction A, and the handheld member 343 forces the engagement member 342 to move relative to the fixed member 341 along a direction opposite to the direction B, so that the engagement member 342 is engaged with the engagement hole 22 of the casing 20. At this time, the second assembly structure 34 is changed from the released state to the assembled state, and the bottom plate 311 of the disk drive assembly 30 is fixed to the casing 20. Finally, the fastener 40 is screwed into the first assembly structure 33, so that the disk drive assembly 30 is fixed to the casing 20.

Compared with the conventional disk drive assembly which merely fixes the front side of the disk drive assembly to the casing, in this embodiment, when the disk drive assembly 30 is required to be removed from the casing 20, it is necessary to pull the handheld member 343 of the second assembly structure 34. At this time, it may be checked whether the external cables are still plugged into the two backplanes 35 of the disk drive assembly 30 or not. That is, the second assembly structure 34 located at the back side 317 of the disk drive assembly 30 not only further fix the disk drive assembly 30 on the casing 20, but also avoid the external cables from being torn since the disk drive assembly 30 is not completely removed from the casing 20.

According to the disk drive assembly, the mounting cage assembly and the server disclosed by above embodiments, due to the addition of the second assembly structure at the back side with larger space of the disk drive assembly, the front side with small space of the disk drive assembly needs to lock a single screw to fix the disk drive assembly to the casing merely without locking a plurality of screws. Therefore, the time for installing the mounting cage of the server may be reduced and the convenience of installation may be increased.

In addition, since the second assembly structure is located at the back side of the disk drive assembly, when removing the disk drive assembly, the operator may check whether the external cables are completely removed from the disk drive assembly so as to avoid tearing the external cables when removing the disk drive assembly.

It will be apparent to those skilled in the art that various modifications and variations can be made to the present invention. It is intended that the specification and examples be considered as exemplary embodiments only, with the scope of the invention being indicated by the following claims and their equivalents.

What is claimed is:

1. A disk drive assembly, comprising:
a mounting cage, having a front side, a back side and at least one installation space, wherein the back side is opposite to the front side, and the at least one installation space extends from the front side to the back side;
at least one disk drive, mounted in the at least one installation space; and
a first assembly structure and a second assembly structure, located adjacent to the front side and the back side of the mounting cage, respectively.

2. The disk drive assembly according to claim 1, wherein the mounting cage has a bottom plate, two side plates and a top plate, the two side plates are connected to two opposite sides of the bottom plate, respectively, two opposite sides of the top plate are connected to the two side plates, respectively, the bottom plate, the two side plates and the top plate together form the at least one of the installation space, the first assembly structure is located on the top plate, and the second assembly structure is located on the bottom plate.

3. The disk drive assembly according to claim 2, wherein the at least one of the installation space comprises two installation spaces, the mounting cage further comprises a partition, the partition is located between the bottom plate and the top plate and connected to the two side plates, and the bottom plate, the two side plates and the top plate together form the two installation spaces.

4. The disk drive assembly according to claim 2, wherein the first assembly structure is a screw hole.

5. The disk drive assembly according to claim 2, wherein the second assembly structure comprises a fixed member, an engagement member and a handheld member, the fixed member is fixed on the bottom plate, the engagement member is movably disposed at the fixed member, and the handheld member is movably disposed at the engagement member and is configured to force the engagement member to move relative to the fixed member.

6. The disk drive assembly according to claim 5, wherein the handheld member is pivotally connected to the engagement member.

7. A mounting cage assembly, comprising:
a mounting cage, having a front side, a back side and at least one installation space, wherein the back side is opposite to the front side, and the at least one installation space extends from the front side to the back side; and
a first assembly structure and a second assembly structure, being close to the front side and the back side of the mounting cage, respectively.

8. A server, comprising:
a casing; and
a disk drive assembly, comprising:
a mounting cage, having a front side, a back side and at least one installation space, wherein the back side is opposite to the front side, and the at least one installation space extends from the front side to the back side;
at least one disk drive, mounted in the at least one installation space; and
a first assembly structure and a second assembly structure, located adjacent to the front side and the back side of the mounting cage, respectively.

9. The server according to claim 8, wherein the first assembly structure is a screw hole.

10. The server according to claim 8, wherein the second assembly structure comprises a fixed member, an engagement member and an handheld member, the fixed member is fixed on the mounting cage, the engagement member is movably disposed at the fixed member, and the handheld member is movably disposed at the engagement member and is configured to force the engagement member to move relative to the fixed member.
